(19) United States
(12) Patent Application Publication
(10) Pub. No.: US 2013/0285391 A1
(43) Pub. Date: Oct. 31, 2013

(54) LOCK DEVICE FOR SLIDING WINDOWS

(71) Applicant: Glen M. Wolf, Owatonna, MN (US)

(72) Inventor: Glen M. Wolf, Owatonna, MN (US)

(73) Assignee: Truth Hardware Corporation, Owatonna, MN (US)

(21) Appl. No.: 13/843,378

(22) Filed: Mar. 15, 2013

Related U.S. Application Data
(60) Provisional application No. 61/640,412, filed on Apr. 30, 2012.

(51) Int. Cl. E05C 3/14

(52) U.S. Cl. CPC E05C 3/14
USPC 292/241

(57) ABSTRACT

A locking system for sliding windows. The system includes a lock assembly that uses plastic components designed for enhanced strength. The system can be readily aligned in manufacturing through the use prefabricated aspects on the lock rail of a sash that complement features on the lock assembly. The system can also be assembled using a single mounting fastener for ease of assembly in manufacturing.

### RELATED APPLICATIONS

This application claims the benefit of U.S. Provisional Application No. 61/640,412, entitled LOCK DEVICE FOR SLIDING WINDOWS, filed Apr. 30, 2012, said application hereby fully incorporated herein by reference.

### FIELD OF THE INVENTION

The disclosed invention relates generally to the windows. More specifically, the invention relates locking systems for sliding windows.

### BACKGROUND OF THE INVENTION

Window manufacturers typically use locking devices on the sash meeting rails of sliding window assemblies to provide environmental control and security, and to prevent unintentional opening of the windows. Plastic or composite locks are preferred for reasons of aesthetics, cost reduction, and corrosion resistance. However, plastic locks tend to be weaker than metal locks and typically do not perform as well as metallic locks under loading conditions. Manufacturers also desire to minimize fasteners for faster and easier assembly of the locks to the window, as well as for aesthetic reasons.

What is needed in the industry is a window locking device primarily of plastic or composite components with enhanced performance characteristics and ease of assembly.

### SUMMARY OF THE INVENTION

Various embodiments of the invention provide a window lock having plastic components with improved load performance, that is easily assembled in the manufacturing environment, and that is adaptable to a variety of window applications and in a variety of aesthetic designs. The assembly requires only a few components and is readily assembled in a top-down fashion for augmentation in an automated assembly environment.

U.S. Pat. No. 3,645,573 to Strang (“Strang”) discloses the use of single screw that passes through a lock element and base, the base having spurs positioned laterally from the screw for penetrating the wood surface of a sash to prevent the assembly from rotating during installation of the screw and to resist torsion during operation. The device of Strang is lacking in several respects. The spurs are inoperable with certain sash materials such as metals and harder polymers. Even where a wooden sash is utilized, the diminutive size of the spurs that are necessary for penetration of the wood creates high stress in the penetration region during operating of the lock, causing the spurs to tear away with time. The spurs also do little to resist the bending load placed on the assembly, meaning that the screw must bear the majority of the bending load. In addition, the spurs do not assist in the initial translational and rotational alignment of the assembly.

In various embodiments of the invention, a single mounting fastener is used in the center pivot of a handle and a rotating cam. Certain embodiments include a housing, also secured in place by the mounting fastener, that includes a tab feature that is inserted into prefabricated elongate slot on the lock rail of the sash, and/or one or more boss features that are inserted into a prefabricated hole or holes. The tab feature is easy to insert into the lock rail and the lock is held down securely due to the slight spring bias created by the tab and the mounting fastener. The tab feature can provide relief of the fastener against bending under load conditions, and can also assist in securing the lock assembly tightly against the lock rail. The boss features are of large diameter to provide load distribution and reduced stresses on the boss features as well as on the lock rail. The boss features are also positioned at the forward corners of the housing to provide the greatest distance possible between the boss features and the rotation axis of the lock assembly, thereby minimizing shear load on the boss features under the torsional load.

Mounting of the lock assembly is streamlined by the tab feature and boss feature(s) of the housing and by the need for only a single mounting fastener to secure the lock assembly to the lock rail of the sash. Actuation of the mounting fastener also acts to finally and permanently secure the rotating cam to the handle.

In an embodiment, a lock device for a sliding window includes a lock housing having a peripheral wall defining a recess. A sweep cam is received in the recess of the lock housing and selectively rotatable relative to the housing with a handle. The lock device further includes a fastener extending through the handle, sweep cam, and housing to secure the lock device to a sash of the sliding window, wherein the housing presents at least one downward projection on the peripheral wall of the housing for engaging in a corresponding recess in the sash of the window.

In an embodiment, the at least one downward projection comprises a tab receivable in a slot in the window sash. In another embodiment, the at least one downward projection comprises a boss. In a further embodiment, the housing presents three downward projections on the peripheral wall of the housing. The three downward projections can comprise a tab and two bosses.

In a further embodiment, a sliding window system includes a frame, a first sash slidably disposed in the frame, and a second sash slidably disposed in the frame, the first sash defining at least one recess in a rail of the sash. The system further includes a lock device including a lock housing having a peripheral wall defining a recess, a sweep cam received in the recess of the lock housing and selectively rotatable relative to the housing with a handle, and a fastener extending through the handle, sweep cam, and housing to secure the lock device to the first sash, wherein the housing presents at least one downward projection on the peripheral wall of the housing, the at least one downward projection engaged in the at least one recess in the rail of the first sash.

### BRIEF DESCRIPTION OF THE DRAWINGS

The embodiments of the present invention may be more completely understood in consideration of the following detailed description of various embodiments in connection with the accompanying drawings, in which:

FIG. 1 is a cutaway view of a locking system in an embodiment of the invention;

FIG. 1a is an isometric view of a window according to an embodiment of the invention;

FIGS. 2 and 3 are a perspective views of a lock assembly in an embodiment of the invention;

FIG. 4 is a perspective view of a handle of the lock assembly of FIG. 2 in an embodiment of the invention;

FIGS. 5 and 6 are a perspective views of a housing of the lock assembly of FIG. 2 in an embodiment of the invention;

FIGS. 7 and 8 are a perspective views of a rotating cam of the lock assembly of FIG. 2 in an embodiment of the invention;

FIG. 9 is a perspective view of a bushing of the lock assembly of FIG. 2 in an embodiment of the invention;

FIG. 10 is a perspective view of a keeper of the lock system of FIG. 1 in an embodiment of the invention;

FIG. 11 is an exploded view of the lock assembly of FIG. 2;

FIGS. 12 and 13 are sectional views of the lock assembly of FIG. 2 during assembly;

FIG. 14 is a partial plan view of an inner sash and an outer sash with prefabricated aspects in an embodiment of the invention; and

FIG. 15 is a sectional view of the lock system of FIG. 1.

While the present invention is amenable to various modifications and alternative forms, specifics thereof have been shown by way of example in the drawings and will be described in detail. It should be understood, however, that the intention is not to limit the present invention to the particular embodiments described. On the contrary, the intention is to cover all modifications, equivalents, and alternatives falling within the spirit and scope of the present invention.

### DETAILED DESCRIPTION

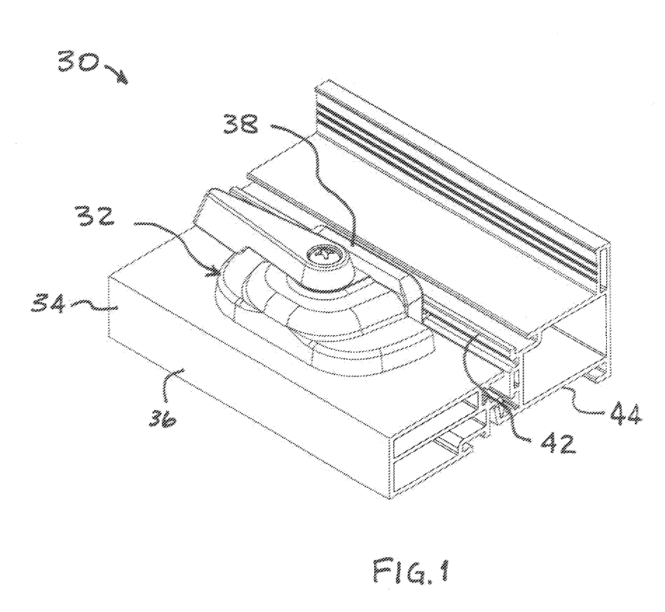

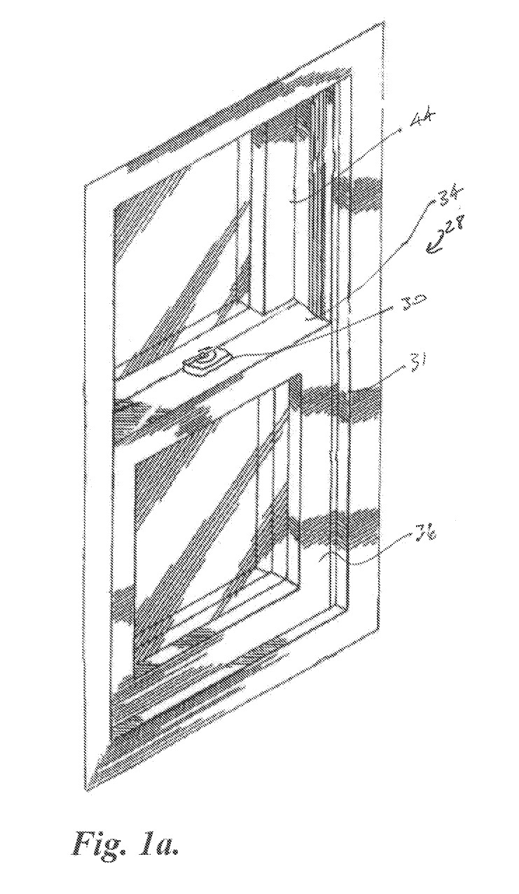

In FIG. 1a there is depicted a double-hung sliding window 28 with a lock assembly 30 according to an embodiment of the invention. Window 28 generally includes inner sash 36 and outer sash 44 slidably disposed in frame 31 as is generally known in the art.

Referring to FIG. 1, a locking system 30 for a sliding window is depicted in an embodiment of the invention. The locking system 30 includes a lock assembly 32 coupled to a lock rail 34 of the inner sash 36 of a window. The lock assembly 32 is generally aligned with a keeper 38 that is mounted on an interior side 42 of an outer sash 44 of the window.

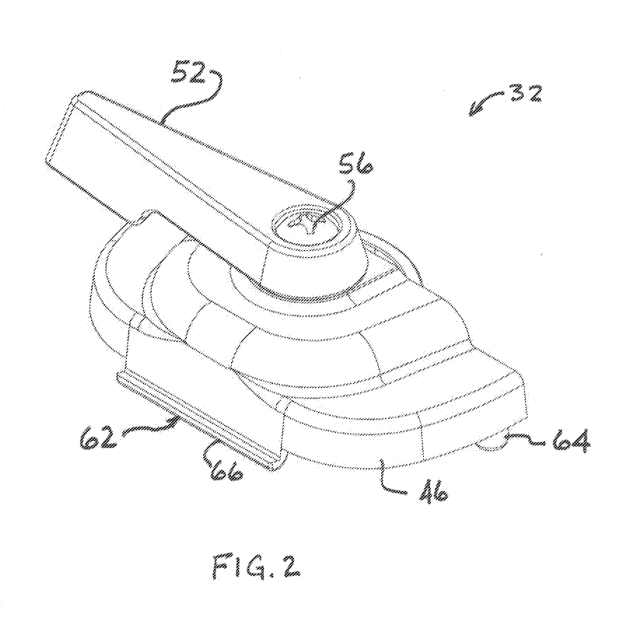

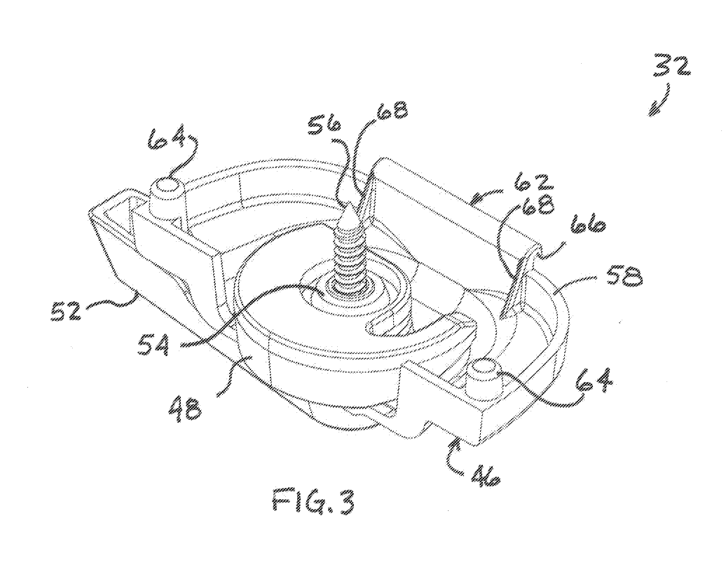

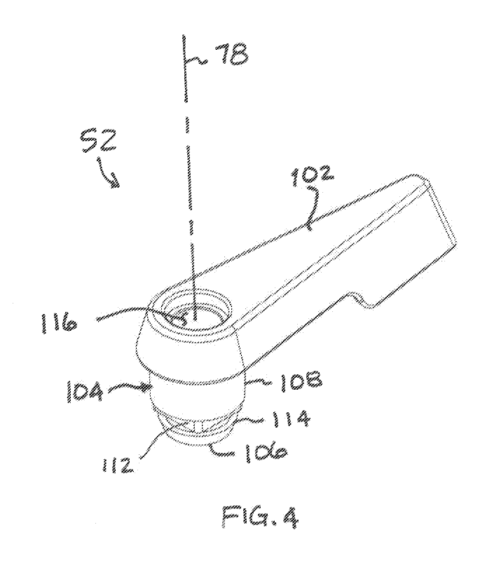

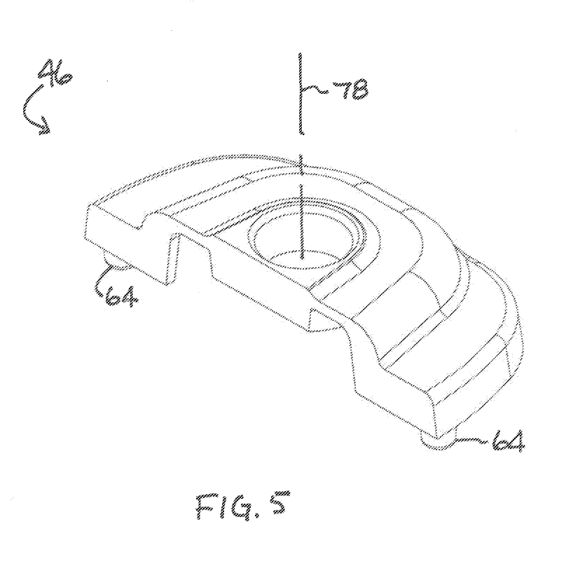

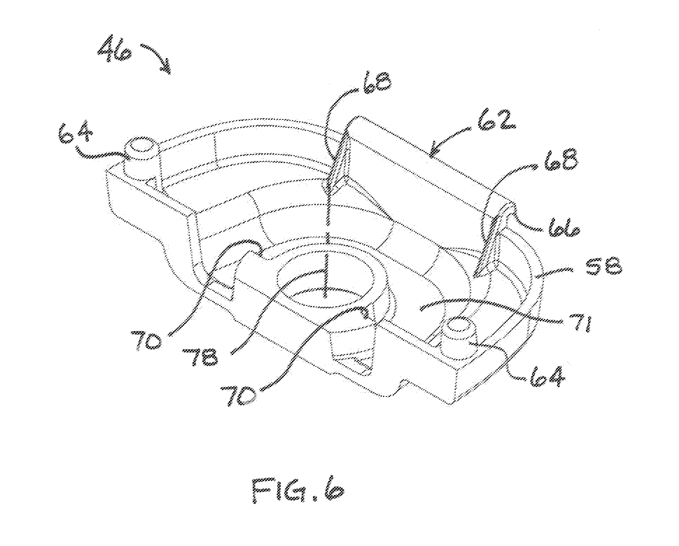

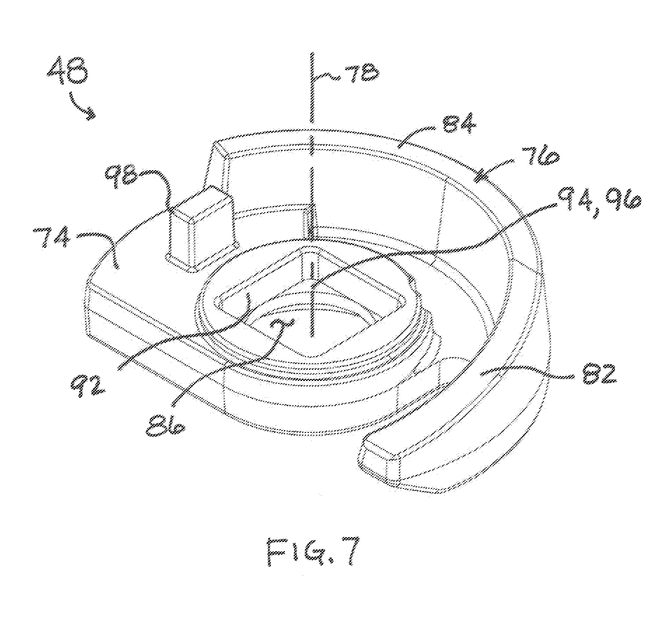

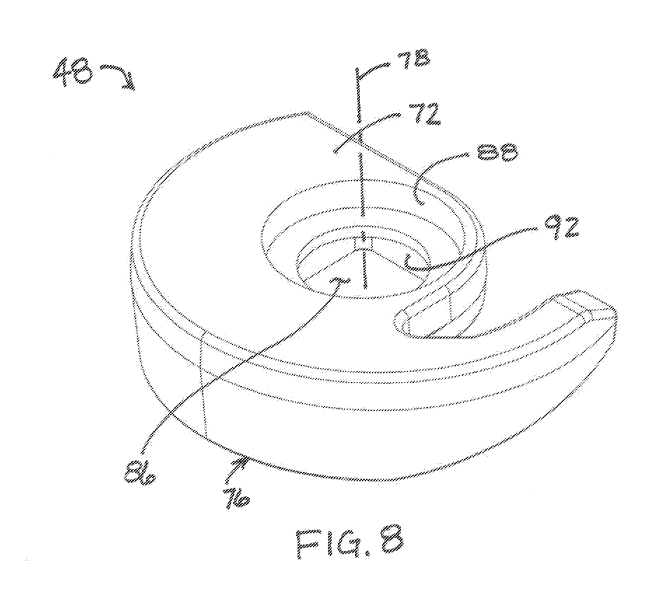

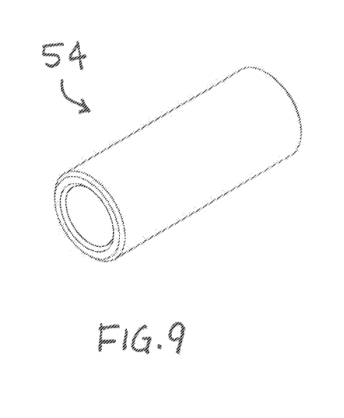

Referring to FIGS. 2 through 10, the lock assembly 32 and its individual components are depicted in an embodiment of the invention. In the depicted embodiment, the lock assembly 32 comprises a housing 46, a rotating cam 48, a handle 52, and a bushing 54. The lock assembly 32 is used in conjunction with a mounting fastener 56.

In various embodiments, the housing 46 includes a mounting face 58 that defines a mounting plane. The housing 46 can also include at least one tab feature 62 and one or more boss features 64 that extend through the mounting plane. The tab feature 62 can include a flared end 66 as well as vertical gussets 68 that enhance the strength and stiffness of the tab feature 62. Any number of boss feature(s) 64 can be utilized, or no boss features at all. Alternatively, snap features (not depicted) that snap into corresponding holes in the lock rail 34 can be used instead of or in addition to the boss features 64. The housing 46 can also include stop bosses 70 that extend from an interior surface 71 of the housing 46.

The rotating cam 48 can include a first face 72 that is substantially planar and a second face 74 opposite the first surface, with an outer ridge 76 that extends parallel to a rotation axis 78 from the second face 74. The outer ridge 76 can include a ramp portion 82 and a plateau portion 84. In one embodiment, the rotating cam 48 defines a through-passage 86 about the rotation axis 78 having a circular opening 88 on the first face 72 that is concentric with a square or otherwise polygonal opening 92 on the second face 74. The square or polygonal opening 92 defines a square or polygonal recess 94 that extends partway through the thickness of the rotating cam 48 to define a registration face 96 that extends radially inward at confluence between the circular and square openings 88 and 92. The rotating cam 48 can also include a stop feature 98 on the second face 74.

The handle 52 includes a lever portion 102 and a hub portion 104, the hub portion 104 having a distal end 106. The hub portion 104 comprises a barrel portion 108, a tenon portion 112 distal to the barrel portion 108, and a retaining feature or features 114 formed at the distal end 106 of the hub portion 104. The tenon portion 112 is adapted to fit within the square or polygonal recess 94 of the rotating cam 48. A pivot passage 116 is defined that passes through the lever portion 102 and hub portion 104. In one embodiment, the distal end 106 of the hub portion 104 is formed to have an inner diameter 118 that is slightly reduced relative to portions of the pivot passage 116 that pass through the lever portion 102, barrel portion 108 and tenon portion 112.

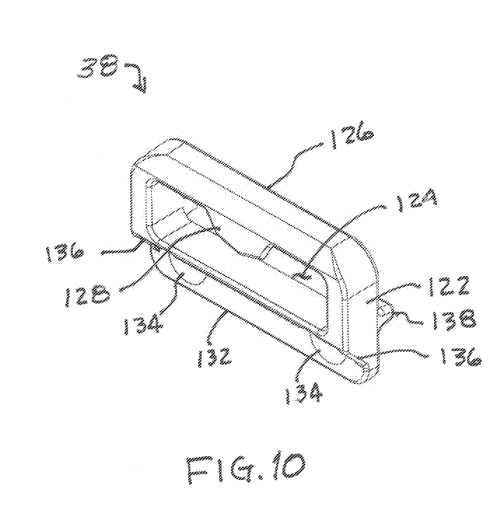

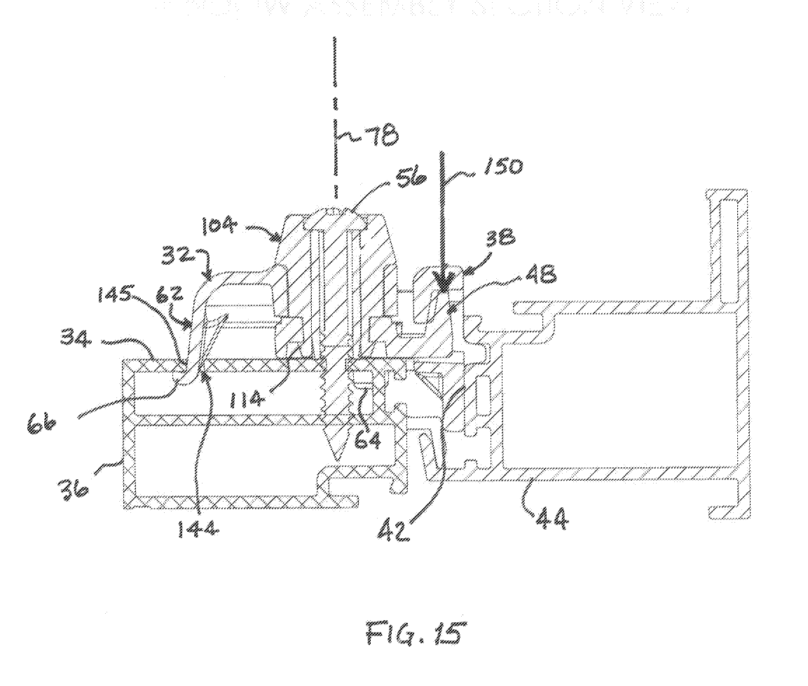

In one embodiment of the invention, the keeper 38 (FIG. 10) is mounted on the interior side 42 of the outer sash 44 of the window (FIGS. 1 and 15) and is generally aligned with the lock assembly 32. The keeper 38 can include a frame portion 122 defining an opening 124 and a mounting face 126. One of the frame members can include a lip portion 128 that extends partially over the opening 124. The frame can also include a mounting member 132 that defines one or more holes 134 for accommodating fasteners, and gussets 136 for enhanced strength. In one embodiment, the frame includes a rib 138 that projects from the mounting face 126.

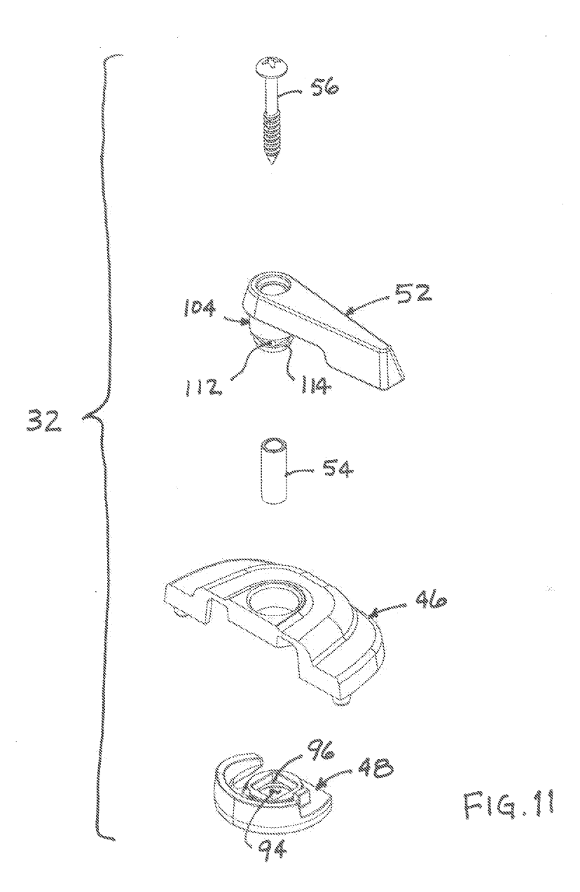

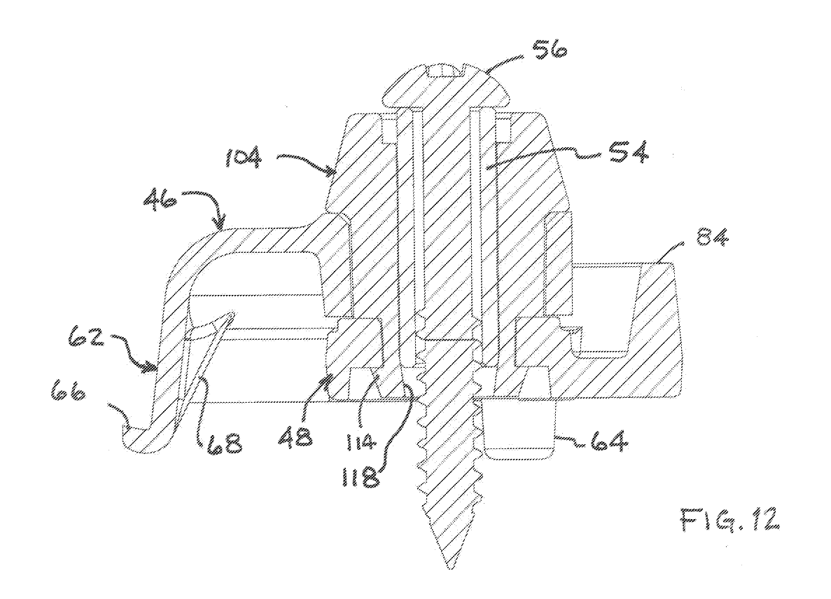

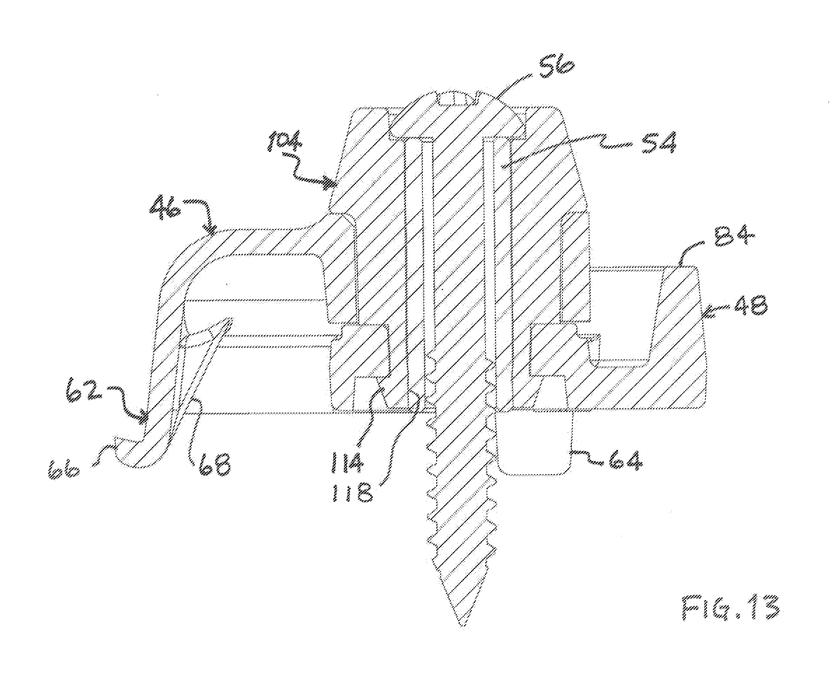

Referring to FIGS. 11 through 13, assembly of the lock assembly 32 is depicted in an embodiment of the invention. In the depicted embodiment, the handle 52 is inserted into the housing 46 and the rotating cam 48 is inserted over the tenon portion 112 of the handle 52. The rotating cam 48 is pressed onto the tenon portion 112 of the hub portion 104 so that the tenon portion 112 is seated against the registration face 96 of the square or polygonal recess 94 and so that the circular aperture of the rotating cam 48 snaps over the retaining feature or features 114 on the distal portion the hub portion 104. The bushing 54 is inserted into the opening of the pivot passage 116 on the handle 52 (FIG. 12) and driven through the hub portion 104 to the distal end 106 (FIG. 13). As the bushing 54 passes through the reduced inner diameter 118 of the distal end 106 of the hub portion 104, the retaining features 114 of the barrel portion 108 are flared radially outward, thereby preventing the retaining feature or features 114 from collapsing inward under load conditions. Accordingly, the rotating cam 48 is positively secured to the handle 52.

It is noted that driving the mounting fastener 56 during mounting of the lock assembly 32 to the inner sash 36 can act to deploy the retaining features 114 radially outward as described above.

Functionally, the various mechanisms described above positively secure the rotating cam 48 to the handle 52. The tenon portion 112 and square or polygonal recess 94 cause rotational coupling between the handle 52 and the rotating cam 48. The bushing 54 positively interlocks the retaining features 114 of the barrel portion 108 to the rotating cam 48 to prevent separation of these components along the rotation axis 78. Accordingly, the lock assembly 32 will not loosen or come apart over time.

The mounting fastener 56 passes through the housing 46, handle 52 and rotating cam 48 for fastening the lock assembly 32 to the lock rail 34 and distributes the load on the rotating cam 48 to the lock rail 34. Alternatively, in place of the mounting fastener 56, a boss (not depicted) could extend from either the handle 52 or cam 48 or some other separate component into a hole in the lock rail 34 to provide a means to help distribute loading on the rotating cam 48 to the lock rail 34 in a similar fashion.

The bushing 54 can also provide vertical support for the mounting fastener 56 by carrying the compression force exerted by the mounting fastener 56, thus enabling the handle 52 and rotating cam 48 to rotate freely. The bushing 54 further isolates the handle 52 from contact with the mounting fastener 56, so that the actuation motion does not cause wear between the handle 52 and the mounting fastener 56 or otherwise cause loosening of the mounting fastener 56.

In operation, the handle 52 is actuated to rotate the rotating cam 48 within the housing 46 between the locked and unlocked positions. As the rotating cam 48 is rotated from the unlocked to the locked position, the outer ridge 76 of the cam 52 passes behind and engages with the lip portion 128 of the keeper 38, which couples the lock assembly 32 to the keeper 38. The ramp portion 82 of the outer ridge 76 can function to align the inner and outer sashes 36 and 44 during actuation of the rotating cam 48. The stop feature 98 of the rotating cam 48 engages with the stop bosses 70 on the housing 46 at both extremes of operation to prevent the rotating cam 48 from rotating past the fully locked and the fully unlocked positions.

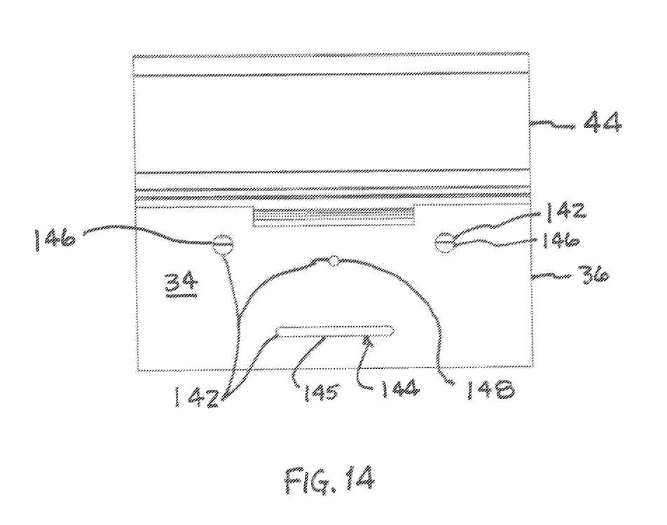

Referring to FIGS. 14 and 15, assembly of the lock assembly 32 and lock system 30 are depicted in an embodiment of the invention. Prefabricated aspects 142 of the lock rail 34 of the inner sash 36 are depicted in FIG. 14. In this embodiment, the prefabricated aspects 142 include an elongate slot 144 and two alignment holes 146 to receive the tab feature 62 and boss features 64, respectively. The prefabricated aspects 142 can also include a pre-drilled hole 148 for accepting the fastener 56. In other embodiments, the prefabricated aspects 142 can include a plurality of alignment slots and any number of alignment holes.

The lock assembly 32 can be mounted to the lock rail 34 by tipping the housing 46 at approximately a 30 degree angle and aligning the tab feature 62 with the elongate slot 144 in the lock rail 34 and inserting the end of the tab feature 62 into the elongate slot 144 and then rotating the housing 46 downward until the boss features 64 of the housing 46 go into the holes in the lock rail 34 and the bottom of the housing 46 rests on the lock rail 34. The vertical gussets 68 on the tab feature 62 act to positively register the tab feature 62 against an outward edge 145 of the elongate slot 144 (FIG. 14), thus preventing the flared end 66 of the tab feature 62 from becoming dislodged. The mounting fastener 56 is then assembled in the center pivot hole of the handle 52 and driven into the lock rail 34 to secure the lock assembly 32.

Functionally, the use of a single mounting fastener 56 speeds assembly while providing a secure method of mounting the lock assembly 32 to the lock rail 34. The boss features 64 provide alignment of the lock assembly 32 on the inner sash 36. The tab feature 62 can be formed to put a slight spring downward bias of the aft portion (i.e., the portion between the fastener 56 and the tab 62) of the lock assembly 32 against the mounting surface of the lock rail 34 to aid in securing the lock assembly 32 to the inner sash 36. The downward spring bias can also mitigate the effects of gapping if the lock rail 34 profile thickness varies or there is warpage/bow present in the lock rail 34.

It is noted that the same aspects that facilitate the mounting of the lock assembly 32 can improve the performance of the locking system 30 under loading conditions. The tab feature 62 of the housing 46, being located on the opposing side of the mounting fastener 56 from the engagement of the rotating cam 48 and keeper 38, can operate to counter moments imparted to the lock assembly 32 under an axial load 150 (FIG. 15). The greater distance between the tab feature 62 and the rotation axis 78, the greater leverage for relieving the bending stress that is otherwise placed on the mounting fastener 56. The width of the tab feature 62 can be maximized for better distribution and reduced stress under axial loads. Accordingly, the tab feature 62 provides additional strength that prevents the lock assembly 32 from being dislodged from the inner sash 36 due to axial loads between the cam 48 and the keeper 38.

Also, the boss features 64 are spaced forward of the rotating cam 48 center and laterally as far out as possible from the rotation axis 78 to provide rigidity and strength under torsion loads about the rotation axis 78. The mounting fastener 56 acts as a strengthening member in the center pivot area as well as a means to help secure the lock assembly 32. The mounting fastener 56 transfers the load into the lock rail 34 and helps prevent separation of the rotating cam 48 from the handle 52.

In certain embodiments, the lock assembly 32 can include either a detent feature molded in the housing 46 which interfaces with the rotating cam 48 or handle 52, or have another separate component to create a detent feature. The detent feature acts to positively secure the rotating cam 48 in either the fully locked or the fully unlocked position, and can help prevent the cam from being jimmied to rotate out of the locked position.

In another embodiment, a thrust washer (not depicted) can be utilized to help reduce axial play in the assembled components. Optionally, a thrust feature (not depicted) can molded in the one or more of the various components of the lock assembly 32 that interfaces with the housing 46, rotating cam 48 or handle 52, or another separate component to reduce axial play between the components.

In the embodiments depicted herein, the non-limiting materials of construction for the lock assembly 32 include plastic for the housing 46 and handle 52 and metal for the rotating cam 48, bushing 54 and mounting fastener 56. Each of these components can be made of plastic, composite (e.g., fiberglass, plastic-impregnated wood), metal or other materials or combinations thereof known to the artisan. The locking system 30 can be used with vinyl plastic, aluminum, wood, composite or other window sash materials.

References to relative terms such as upper and lower, front and back, left and right, or the like, are intended for convenience of description and are not contemplated to limit the invention, or its components, to any specific orientation. All dimensions depicted in the figures may vary with a potential design and the intended use of a specific embodiment of this invention without departing from the scope thereof.

Each of the additional figures and methods disclosed herein may be used separately, or in conjunction with other features and methods, to provide improved devices, systems and methods for making and using the same. Therefore, combinations of features and methods disclosed herein may not be necessary to practice the invention in its broadest sense and are instead disclosed merely to particularly describe representative embodiments of the invention.

For purposes of interpreting the claims for the present invention, it is expressly intended that the provisions of 35 U.S.C. §112(f) are not to be invoked unless the specific terms “means for” or “step for” are recited in the subject claim.

1. A lock device for a sliding window comprising
a lock housing having a peripheral wall defining a recess;
a sweep cam received in the recess of the lock housing and selectively rotatable relative to the housing with a handle; and
a fastener extending through the handle, sweep cam, and housing to secure the lock device to a sash of the sliding window, wherein the housing presents at least one downward projection on the peripheral wall of the housing for engaging in a corresponding recess in the sash of the window.

2. The lock device of claim 1, wherein the at least one downward projection comprises a tab receivable in a slot in the window sash.

3. The lock device of claim 1, wherein the at least one downward projection comprises a boss.

4. The lock device of claim 1, wherein the housing presents three downward projections on the peripheral wall of the housing.

5. The lock device of claim 4, wherein the three downward projections comprise a tab and two bosses.

6. The lock device of claim 1, wherein the lock housing is formed from plastic.

7. A sliding window system comprising:
a frame;
a first sash slidably disposed in the frame, and a second sash slidably disposed in the frame, the first sash defining at least one recess in a rail of the sash;
a lock device comprising:
a lock housing having a peripheral wall defining a recess;
a sweep cam received in the recess of the lock housing and selectively rotatable relative to the housing with a handle; and
a fastener extending through the handle, sweep cam, and housing to secure the lock device to the first sash, wherein the housing presents at least one downward projection on the peripheral wall of the housing, the at least one downward projection engaged in the at least one recess in the rail of the first sash.

8. The window system of claim 7, wherein the at least one downward projection comprises a tab and the at least one recess in the rail of the sash comprises a slot.

9. The window system of claim 7, wherein the at least one downward projection comprises a boss.

10. The window system of claim 7, wherein the housing presents three downward projections on the peripheral wall of the housing.

11. The window system of claim 10, wherein the three downward projections comprise a tab and two bosses.

12. The window system of claim 7, wherein the lock housing is formed from plastic.
